(19) United States
(12) Patent Application Publication
(10) Pub. No.: US 2026/0118824 A1
(43) Pub. Date: Apr. 30, 2026

(54) TIMEPIECE

(71) Applicant: CASIO COMPUTER CO., LTD., Tokyo (JP)

(72) Inventors: Takashi SUIZU, Tokyo (JP); Moeko SHIMOKAWA, Tokyo (JP)

(73) Assignee: CASIO COMPUTER CO., LTD., Tokyo (JP)

(21) Appl. No.: 19/375,286

(22) Filed: Oct. 31, 2025

(30) Foreign Application Priority Data
Oct. 31, 2024 (JP) 2024-191632

(51) Int. Cl. G04B 19/04; G04B 19/02

(52) U.S. Cl. CPC G04B 19/044; G04B 19/02

(57) ABSTRACT

A timepiece according to an embodiment includes: a first magnet fixed to a first pointer; a second magnet facing the first magnet; a first shaft fixed to the second magnet; a restricting member including an engaging shaft engaged with the first shaft and a cover arranged on one side of the second magnet and facing the second magnet via the first magnet; and a windshield member. The engaging shaft of the restricting member has a length greater than a distance between a surface of the restricting member on the one side and the windshield member.

### CROSS-REFERENCE TO RELATED APPLICATIONS

This application is based upon and claims the benefit of priority from Japanese Patent Application No. 2024-191632, filed October 31, 2024, the entire contents of which are incorporated herein by reference.

### FIELD

The present disclosure relates to a timepiece.

### BACKGROUND

For example, Jpn. Pat. Appln. KOKAI Publication No. S50-46162 discloses a timepiece pointer mechanism utilizing a magnetic force of magnets, in which a first magnet (driven magnet) fixed to a first pointer (second hand), a second magnet (driving magnet) facing the first magnet (driven magnet), and a first shaft (fourth wheel shaft) fixed to the second magnet (driving magnet) are provided. However, even with such a pointer supporting structure, detachment of the first magnet (driven magnet) fixed to the first pointer (second hand) could occur once the structure receives an external impact or is dropped.

### SUMMARY

A timepiece according to an embodiment includes: a first magnet fixed to a first pointer; a second magnet facing the first magnet; a first shaft fixed to the second magnet; a restricting member including an engaging shaft engaged with the first shaft and a cover arranged on one side of the second magnet and facing the second magnet via the first magnet; and a windshield member. The engaging shaft of the restricting member has a length greater than a distance between a surface of the restricting member on the one side and the windshield member.

Further features of the present invention will become apparent from the following description of exemplary embodiments suitably given with reference to the accompanying drawings.

### BRIEF DESCRIPTION OF THE DRAWINGS

FIG. 1 is a plan view showing a configuration of a timepiece according to a first embodiment.

FIG. 2 is a sectional view showing a configuration of the timepiece.

FIG. 3 is a sectional view showing a configuration of a pointer and a gear train mechanism of the timepiece.

FIG. 4 is an illustrative drawing for a partial configuration of the pointer and the gear train mechanism of the timepiece.

FIG. 5 is an illustrative drawing for a configuration of magnets in the timepiece.

FIG. 6 is an illustrative drawing for a holding structure of the timepiece.

FIG. 7 is a sectional view showing a configuration of a gear train mechanism of a timepiece according to another embodiment.

### DETAILED DESCRIPTION

### First Embodiment

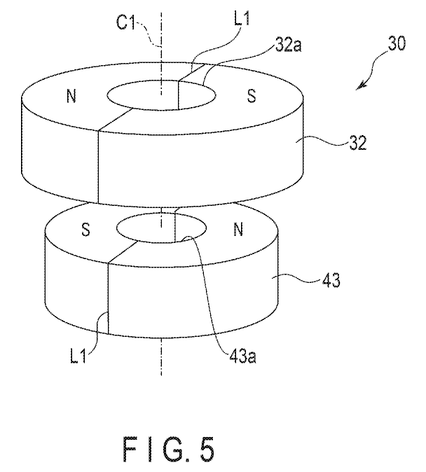

A configuration of a timepiece 10 according to a first embodiment of the invention will be described with reference to FIGS. 1 to 6. The drawings may each schematically show the components in an enlarged size or a reduced size as appropriate, or may omit the components as appropriate.

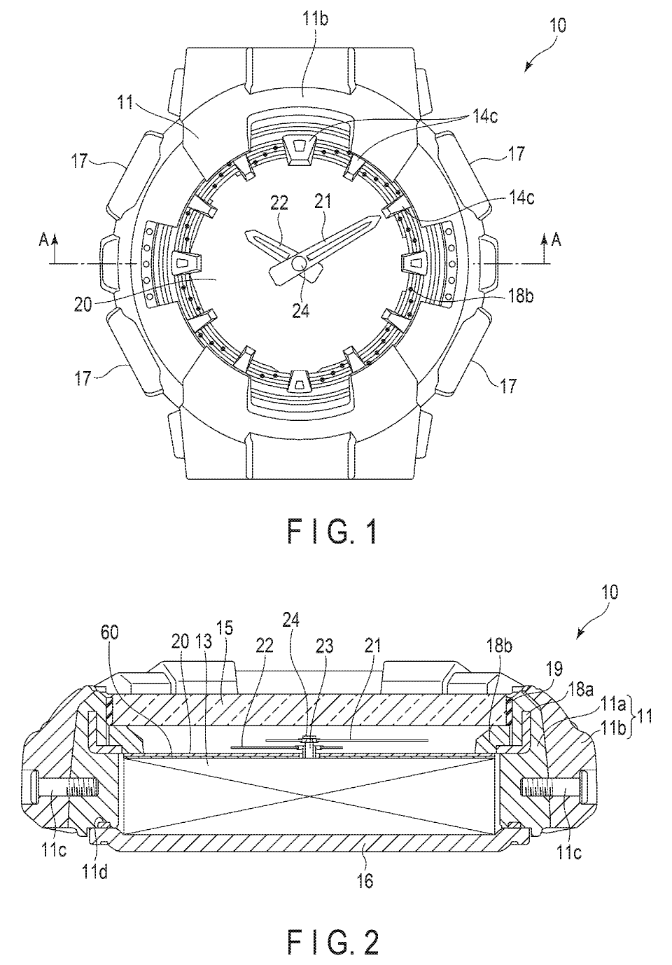

As shown in FIG. 1 and FIG. 2, the timepiece 10 is, for example, a wristwatch which includes a case 11 constituting an outer profile, a timepiece module 13 disposed inside the case 11, a timepiece glass 15 which is a windshield member covering the front side of the timepiece module 13, a back cover 16 covering the back side of the timepiece module 13, and one or more switches 17 arranged at the outer periphery part or parts of the case 11. The case 11 includes a ring-shaped first case 11a and a second case 11b arranged outside the first case 11a.

The first case 11a is formed in a ring shape so as to have a circular accommodating space for accommodating therein the timepiece module 13, etc. In the upper opening of the first case 11a, a face 20 of the timepiece module 13 is arranged. A reinforcing member 18a and a parting member 18b are arranged at the outer peripheral portion of the face 20 and the inner peripheral edge of the first case 11a. Also, a groove is formed in the back side surface (“another surface”) of the first case 11a and a waterproof ring 11d for making an airtight state with the back cover 16 is set into this groove. The second case 11b is arranged along the outer periphery of the first case 11a. The second case 11b is secured to the first case 11a by connecting members such as screws 11c.

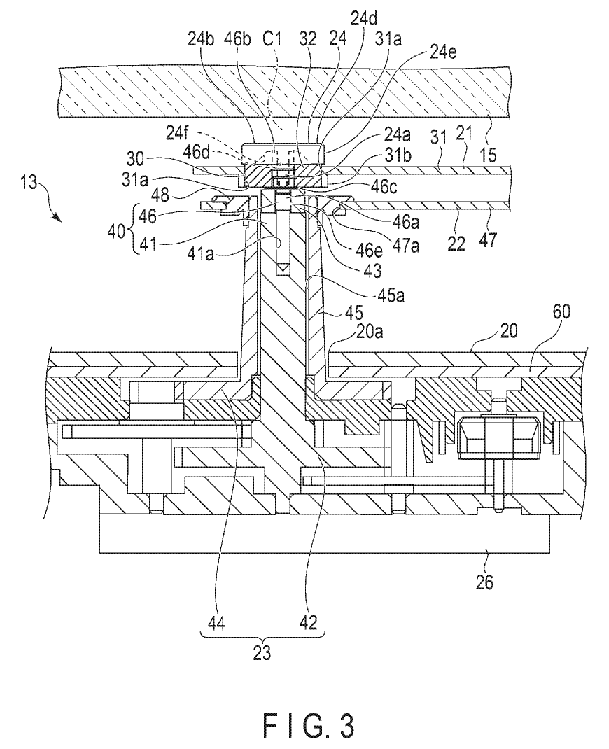

The timepiece module 13 is accommodated in the accommodating space in the first case 11a. The timepiece module 13 includes the face 20, an antimagnetic plate 60, a minute hand 21 as a first pointer, an hour hand 22 as a second pointer, a gear train mechanism 23 as a power transmission unit, a restricting member 24, and a drive source 26 shown in FIG. 3. The timepiece module 13 also includes a variety of components as required for movement of the timepiece according to its drive mode, such as a battery, a circuit board on which electronic parts such as an IC and an antenna are mounted.

The face 20 is formed in a disk shape and arranged in an upper part of the accommodating space of the first case 11a. As shown in FIG. 3, the face 20 includes, at its center part, a through-hole 20a into which a first shaft 40 and a second shaft 45 forming a part of the gear train mechanism 23 are inserted. The parting member 18b provided with various indexes is arranged over the outer peripheral portion of one surface side of the face 20.

The minute hand 21 includes a first pointer body 31 formed in a predetermined width and length. To the minute hand 21, a driven magnet 32 serving as a first magnet is fixed. In one example, the first pointer body 31 is formed as a long and narrow plate. The first pointer body 31 is adapted to rotate and includes a first pointer hole 31a, which is a through-hole, and an edged cylinder portion 31b having an axially extending peripheral edge at the first pointer hole 31a. The driven magnet 32 for the minute hand 21 has a ring shape and is fixed at the first pointer hole 31a of the first pointer body 31. The first pointer body 31 is disposed above the face 20 in the accommodating space in such a configuration as to be rotatable around a rotational axis C1. The first pointer body 31 is connected to the drive source 26 through the gear train mechanism 23 and makes a rotational motion with its longitudinal direction oriented toward the time intended to be displayed.

As shown in FIGS. 3 to 5, the driven magnet 32 is, for example, formed in a ring shape having an axial hole 32a (hole portion) at its center. In one example, the driven magnet 32 is constituted by a ferromagnetic body such as samarium cobalt. The driven magnet 32 is radially magnetized and has two different poles in the circumferential direction. In one example, the driven magnet 32 is polarized to have a south pole on one side and a north pole on the other side with a radial polarization line L1 that passes through the center as a boundary. A support member 46 which is a part of the gear train mechanism 23 is inserted through the axial hole 32a of the driven magnet 32 so that the driven magnet 32 is rotatably supported by the support member 46. The driven magnet 32 is arranged in contact with the first shaft on its flange portion 46c side. Note that the driven magnet 32 may be separated from a later described cover 24b in the axial direction.

The gear train mechanism 23 includes a plurality of gear members provided as appropriate according to the arrangement of the drive source 26 with respect to the minute hand 21, the hour hand 22, etc. As one example, the gear train mechanism 23 at least includes a minute hand gear 42 which is a first rotating wheel including the first shaft 40 engaged with the minute hand 21, and an hour hand gear 44 which is a second rotating wheel including the second shaft 45 engaged with the hour hand 22. The gear train mechanism 23 and the drive source 26 together constitute a movement to move the minute hand 21 and the hour hand 22.

The minute hand gear 42 is a gear member which is a so-called “second wheel” and arranges, at its rotational center, the first shaft 40 extending along the rotational axis C1. The minute hand gear 42 is rotated by the drive source 26 so as to rotate the minute hand 21.

The first shaft 40 includes a shaft body 41 and the aforementioned support member 46 arranged at the end of the shaft body 41. The first shaft 40 is fixed at the rotational center of the minute hand gear 42. Note that, depending on the arrangement relationship with other components, the first shaft 40 may be formed in a cylindrical shape having a through-hole in its center portion so that another shaft member can be inserted into this through-hole. The first shaft 40 may be formed integrally with the minute hand gear 42 or may be formed of different members. Also, the first shaft 40 may be fixed to the minute hand gear 42 or may have a configuration for moving in conjunction with the minute hand gear 42 without being fixed to it.

The shaft body 41 is a rod-shaped member extending in a predetermined first direction. A hole portion 41a into which the support member 46 is inserted for fixation is formed at the end portion of the shaft body 41. In one example, the hole portion 41a is a bottomed recess which opens toward the end side of the shaft body 41, that is, toward the front side of the timepiece 10. The support member 46 is inserted into the hole portion 41a and fixed.

The support member 46 integrally includes a first shaft portion 46a, a first cylindrical portion 46b, and the aforementioned flange portion 46c. The first shaft portion 46a is a shaft member having a smaller diameter than that of the shaft body 41 and is inserted into the hole portion 41a for fixation. The first shaft portion 46a and the shaft body 41 are coaxially supported. The first shaft portion 46a includes an enlarged diameter portion 46e of which an outer peripheral surface facing the axially central portion of the axial hole 43a defines a slightly larger diameter than that of each of the outer peripheral surfaces facing the respective axially end portions of the axial hole 43a.

That is, among the first shaft portion 46a, the outer peripheral surfaces that face the corners of the respective axially end portions of the axial hole 43a of the driving magnet 43 each define a smaller diameter than that of the central portion, so that interference between the first shaft portion 46a and the corners of the driving magnet 43 is prevented.

The first cylindrical portion 46b is arranged on the front side of the first shaft portion 46a. An insertion hole 46d which opens toward the front side and into which a fixing pin 24a (engaging shaft) of the restricting member 24 is inserted is formed in the front side end of the first cylindrical portion 46b. The fixing pin 24a of the restricting member 24 is inserted into the insertion hole 46d and fixed. In one example, the insertion hole 46d is formed to have a depth greater than the thickness of the driven magnet 32.

Note that the support member 46 is, in one example, formed to have such an axial dimension that the surface of the front side end of the first cylindrical portion 46b of the support member 46 projects toward the front side (“one side”) beyond the surface of the front side end of the driven magnet 32. That is, the front side surface of the first cylindrical portion 46b is located further toward the front side (“one side”) than the front side surface of the driven magnet 32. The support member 46 is fixed to the shaft body 41. The support member 46 is arranged in the axial hole 32a of the driven magnet 32 and an axial hole 43a of a driving magnet 43. The support member 46 supports the driven magnet 32 in such a form as to enable the rotation of the driven magnet 32 and restrict the radial shift of the rotating driven magnet 32.

The flange portion 46c is a flange-shaped spacer arranged between the first cylindrical portion 46b and the first shaft portion 46a and projecting in the outer circumferential direction. The flange portion 46c is a projection having a predetermined thickness, and is interposed between the driven magnet 32 and the driving magnet 43 so as to define an axial gap between the driven magnet 32 and the driving magnet 43. The thickness of the flange portion 46c is set, for example, to a size that can permit a necessary holding force from the magnetic properties to be secured.

The driving magnet 43, which serves as a second magnet, is fixed by press-fitting to a back side part of the flange portion 46c, namely, a location between the end surface of the shaft body 41 and the flange portion 46c. On the other hand, the driven magnet 32 is rotatably attached to the front side part of the flange portion 46c, namely, a location that is further toward the front side than the flange portion 46c. That is, the flange portion 46c supports the driven magnet 32 in such a form as to enable the rotation of the driven magnet 32 with a predetermined gap from the driving magnet 43 secured, while regulating the radial position of the driven magnet 32.

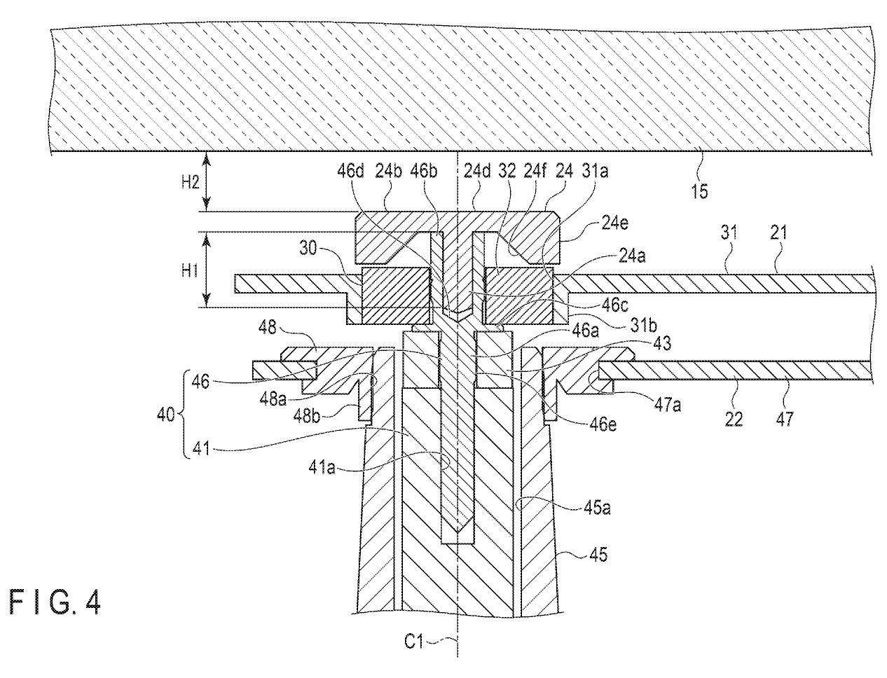

As shown in FIG. 4, for example, the driving magnet 43 is formed in a ring shape having the axial hole 43a at its center so as to be arranged coaxially with the driven magnet 32. In one example, the driving magnet 43 is constituted by a ferromagnetic body such as samarium cobalt. The driving magnet 43 is arranged on the axially back side of the driven magnet 32 and faces the driven magnet 32 via the flange portion 46c. The driving magnet 43 is radially magnetized and has two different poles in the circumferential direction. In one example, the driving magnet 43 is polarized to have a south pole on one side and a north pole on the other side with a radial polarization line L1 that passes through the center as a boundary. The driving magnet 43 is fixed by being pushed against the shaft body 41 by the flange portion 46c of the support member 46 that has been press-fitted into and fixed to the shaft body 41 of the first shaft 40. The driving magnet 43 is rotated together with the first shaft 40. The support member 46, which is a part of the first shaft 40 of the gear train mechanism 23, is placed in the axial hole 43a of the driving magnet 43. The driving magnet 43 is fixed to the first shaft 40 through, for example, a fitting or a bonding technique. The driving magnet 43 is therefore fixed to the minute hand gear 42. The driving magnet 43 faces the driven magnet 32 and causes it to be adsorbed to and held at a rotational position where their south and north poles attract each other. As such, in the stationary state, the driven magnet 32 and the minute hand 21 are held in the rotational direction in which the south and north poles of the magnets attract each other, and in the regular movement state of the timepiece, the minute hand 21 is rotated in synchronization with the rotation of the minute hand gear 42. That is, the driving magnet 43 and the driven magnet 32 form a magnetism-utilizing holding structure 30 in the part of the gear train mechanism 23.

The hour hand 22 includes a second pointer body 47 formed in a predetermined width and length and a washer 48 attached at a second pointer hole 47a of the second pointer body 47. In one example, the second pointer body 47 is formed as a long and narrow plate and includes the second pointer hole 47a at the proximal end for rotation. In one example, the second pointer body 47 is formed in a predetermined shape which is shorter than the first pointer body 31.

The washer 48, which has a ring shape, is attached at the second pointer hole 47a of the second pointer body 47. That is, the second pointer body 47 is fixed to the second shaft 45 which is a part of the gear train mechanism 23, via the washer 48. The second pointer body 47 is rotatably arranged above the face 20 in the accommodating space. The second pointer body 47 is connected to the drive source 26 through the gear train mechanism 23 and makes a rotational motion with its longitudinal direction oriented toward the intended time.

The washer 48 is a ring-shaped plate member including a hole portion 48a through which the second shaft 45 is inserted and a cylindrical portion 48b around the peripheral edge of the hole portion 48a. The washer 48 is attached to the outer periphery of the second shaft 45. The hour hand gear 44 is a gear member which is a so-called “hour wheel” and integrally includes, at its rotational center, the second shaft 45 extending along the rotational axis C1. The hour hand gear 44 is rotated by the drive source 26 so as to rotate the hour hand 22. As shown in FIGS. 3 and 4, the restricting member 24 The antimagnetic plate 60 is arranged adjacent to the face 20 and located on the side opposite to the minute hand 21 as the first pointer and the hour hand 22 as the second pointer, so as to reduce the influence of the magnetic flux from the driving magnet 43 and the driven magnet 32 to the timepiece module 13. The antimagnetic plate 60 is formed in a disk shape with the through-hole 20a of the face 20 located at the center. In one example, the antimagnetic plate 60 is formed of such a material as SPCC (cold-reduced carbon steel sheets and strips), etc. However, the antimagnetic plate 60 is not limited to a material of SPCC, etc., but may adopt any member that is capable of gathering magnetic fields. For example, the antimagnetic plate 60 may be formed of permalloy.

The second shaft 45 is a hollow and rod-shaped member extending in the predetermined first direction. The second shaft 45 is formed in a cylindrical shape having a through-hole 45a in its center portion so that the first shaft 40 can be inserted into the through-hole 45a. The second shaft 45 is rotatably attached to the outer periphery of the first shaft 40. The second shaft 45 is formed integrally with or fixed to the axial center portion of the hour hand gear 44.

The second pointer body 47 is fixed to the end portion of the second shaft 45 via the washer 48. That is, the second pointer body 47 is rotated along with the rotation of the second shaft 45. In one example, the minute hand 21, the first shaft 40, the hour hand 22, and the second shaft 45 are constituted by a magnetic material or materials.

is a retaining member integrally including the fixing pin 24a (engaging shaft) and the cover 24b which serves as a restricting portion. In one example, the restricting member 24 is constituted by a metal material. For example, the restricting member 24 is constituted by a nonmagnetic material such as brass.

The fixing pin 24a is a columnar shaft component having a diameter slightly smaller than that of the insertion hole 46d formed in the support member 46 at the end of the first shaft 40, and is inserted into the insertion hole 46d of the support member 46. That is, the restricting member 24 is connected to the first shaft 40 via the support member 46. Accordingly, even in the event of an external impact which causes the minute hand 21 fixed to the driven magnet 32 to be moved in the direction (toward the timepiece glass 15) where the minute hand 21 would fall out of the insertion hole 46d of the support member 46, the minute hand 21 comes into contact with the inner surface (“another surface”) of the timepiece glass 15 and can be prevented from falling out. Note that the fixing pin 24a may instead be a columnar shaft component that has a slightly larger diameter than that of the insertion hole 46d of the support member 46. In such a configuration, the fixing pin 24a is press-fitted into the insertion hole 46d for fixation, and accordingly, the falling out of the minute hand 21 in the event of an external impact can be prevented.

The cover 24b is formed in a disk shape. The cover 24b is integrally formed at one end of the fixing pin 24a on the proximal side in the insertion direction. In one example, the cover 24b has a circular plate shape larger than the outer profile of the driven magnet 32. The cover 24b faces the driving magnet 43 via the driven magnet 32. The cover 24b is arranged on the front side of the driven magnet 32 and restricts the frontward movement of the driven magnet 32. In other words, since the cover 24b is inserted into the support member 46 at the end of the first shaft 40 via the fixing pin 24a, the cover 24b interferes with the axially moving driven magnet 32, and as such, the cover 24b serves as a restricting portion for regulating the position of the driven magnet 32.

The cover 24b is positioned with its back surface (“another surface”) arranged to face the end surface of the support member 46. That is, since the support member 46 is formed to have such an axial dimension that the surface of the front side end of the support member 46 projects toward the front side slightly beyond the surface of the front side end of the driven magnet 32, the cover 24b faces the front surface of the driven magnet 32 while being in contact therewith. The cover 24b includes a peripheral wall 24e extending toward the driven magnet 32 at the outer periphery of the proximal portion of the fixing pin 24a, so that a circular recess 24f which opens backward is formed around the fixing pin 24a.

The inner wall surface of the peripheral wall 24e, namely, the inner peripheral surface of the recess 24f, is formed in a backwardly expanding tapered shape. The fixing pin 24a is arranged at the center of the inner part of the recess 24f formed inside the peripheral wall 24e.

The fixing pin 24a has an axial length that is increased as the recess 24f is formed in the back surface of the cover 24b and the proximal end of the fixing pin 24a is raised to a higher level. An engagement length H1 which corresponds to the depth of the insertion hole 46d of the support member 46 or the length of the fixing pin 24a (shaft) of the restricting member 24 is set to be larger than an axial distance H2 between the upper surface of the restricting member 24 and the lower surface of the timepiece glass 15. Also, the length of the fixing pin 24a is set to be larger than the thickness of the driven magnet 32, i.e., the axial size of the driven magnet 32.

The drive source 26 includes one or more drive mechanisms. As the drive mechanisms, various drive mechanisms selected from a motor, a wind-up mechanism, and so on may be employed according to the drive mode of the timepiece 10. With the aid of power transmission by the gear train mechanism 23, one drive mechanism may be employed to drive more than one hand including the hands 21 and 22, or multiple drive mechanisms may be employed to drive the respective hands 21 and 22, etc.

The timepiece glass 15 is a so-called windshield member which is made of a light transmissive material shaped as a transparent disk. The timepiece glass 15 is supported above the parting member 18b and along the inner peripheral edge of the upper opening of the first case 11a, and covers the front side of the face 20. In one example, the timepiece glass 15 is attached to the inner peripheral edge of the first case 11a via a gasket 19. The switches 17 are adapted to receive pressing-down operations by an operator for the mode switching, time adjustment, etc. of the timepiece module 13.

In the timepiece 10 with the above-described configurations, the minute hand 21 and a part of the gear train mechanism 23 are coupled together by the holding force of the magnets 32 and 43. Also, the driven magnet 32 of the minute hand 21 is rotatably supported by the support member 46 of the first shaft 40. This can prevent the rotation of the minute hand 21 caused by an external impact from being transmitted to the first shaft 40. For example, in the event that a lateral impact is exerted on the timepiece 10 due to being dropped or the like, a rotational moment is created in the minute hand 21, while the minute hand gear 42 is not subjected to a rotational torque that is equal to or greater than the binding force produced by the magnetic forces from the driving magnet 43 and the driven magnet 32. Accordingly, even if an impact is applied to the minute hand 21 and causes the minute hand 21 to rotate, the first shaft 40 is prevented from rotating so that the inside of the movement can be protected against occurrence of breakage or damage by the rotation of the first shaft 40 due to the external force. Moreover, breakage of the gears due to external force, and breakage of the movement due to slippage or falling out of the press-fitted portion of each hand can also be prevented. Further, in an instance where a motor is employed as the drive source 26, inaccurate time display due to loss of synchronization of the motor magnet can also be prevented.

Still further, in the timepiece 10 where the restricting member 24 including the restricting portion to face the driving magnet 43 via the driven magnet 32 is provided, falling and disengagement of the magnet 32 from the shaft body 41 can be prevented in the event of application of an impact. More specifically, and for example, the driving magnet 43 and the driven magnet 32 face each other and attract each other in the stationary state with their south and north poles correspondingly arranged, so that the driven magnet is properly retained. However, if an impact is applied and the magnets 32 and 43 are shifted into a positional relationship where the poles of one magnet face the repulsive poles of the other magnet, the repulsive force between the magnets can act in the direction where the driven magnet 32 falls from the first shaft 40 and the pointer body is released. Even in such instances, the drifting of the magnet 32 can be restricted with the cover 24b of the restricting member 24 arranged to face the driven magnet 32 on the front side thereof, so that the held state of the magnet can be maintained.

Therefore, the timepiece 10 according to the foregoing embodiment can restore the rotational-direction positional relationship between the driving magnet 43 and the driven magnet 32 to the original state even if the relative displacement occurs between the driving magnet 43 and the driven magnet 32 due to application of an impact. Accordingly, the timepiece 10 can realize an effect wherein the minute hand 21 is returned to the position before the application of an impact with adjustment of the time display. Additionally, the driven magnet 32 and the driving magnet 43 are arranged to face each other in the axial direction, and as such, they do not mutually block the rotational movement.

Moreover, with the support member 46 included in the first shaft 40, the driven magnet 32 can be rotatably supported while using a small space and restricting a radial displacement. Also, the flange portion 46c interposed between the driven magnet 32 and the driving magnet 43 forms an axial gap between the driven magnet 32 and the driving magnet 43. Thus, the occurrence of wear due to the driven magnet 32 and the driving magnet 43 contacting each other can be prevented, and the return of the minute hand 21 to the intended state is not disturbed by the friction that would otherwise be created between the driven magnet 32 and the driving magnet 43 contacting each other.

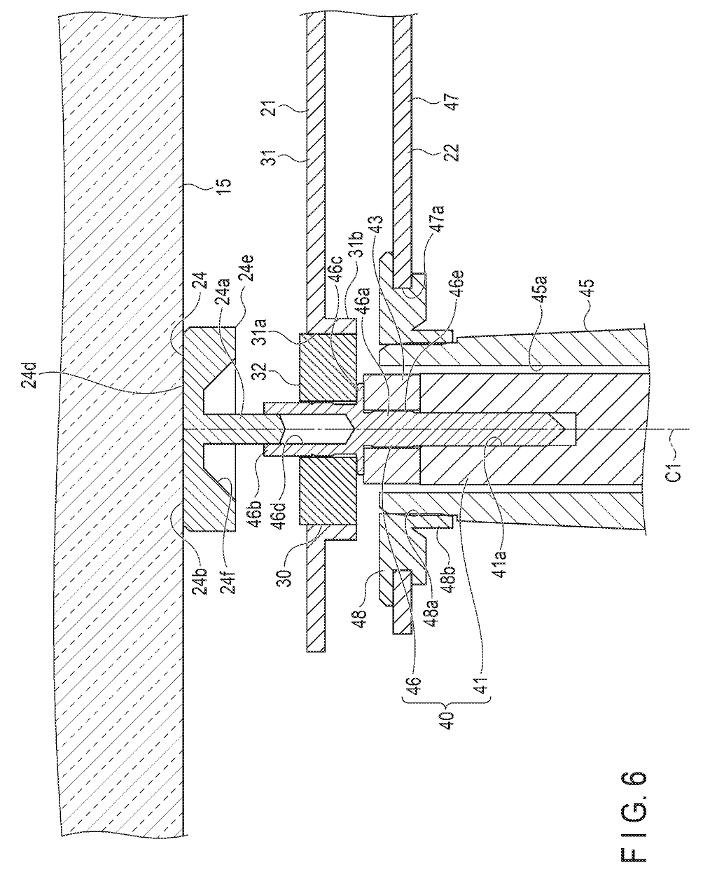

In the timepiece 10, the restricting member 24 includes the fixing pin 24a arranged in the recess 24f, which is formed by the back surface of the restricting member 24 retracted toward the front side. Thus, the length of the fixing pin 24a can be increased as much as the depth of the recess 24f, and accordingly, the falling-out-preventing function can be improved by utilizing the thus-enhanced engagement between the restricting member 24 and the support member 46. More specifically, the fixing pin 24a of the restricting member 24 has the length H1 which is greater than the distance H2 between the restricting member 24 and the timepiece glass 15. Accordingly, even in the event that the restricting member 24 has moved to the front side, the restricting member 24 is stopped by the timepiece glass 15 as shown in FIG. 6, and the falling out and disengagement of the fixing pin 24a from the insertion hole 46d can be prevented. Consequently, the falling-out-preventing function for the minute hand against the external impact can be improved without the need to change the distance between the minute hand 21 and the timepiece glass 15. As one example, supposing that a configuration of fixing the engaging shaft of the restricting member to the support member through press-fitting is adopted, the production process or the repairing work would likely exert a force on the gear train mechanism in the direction of allowing the engaging shaft to fall out, and this could easily cause loosening of the fixed driving magnet. However, with the configuration according to the embodiment, an enhanced engagement is realized through the size setting without using press-fitting fixation, and therefore, the loosening of the driving magnet can be prevented.

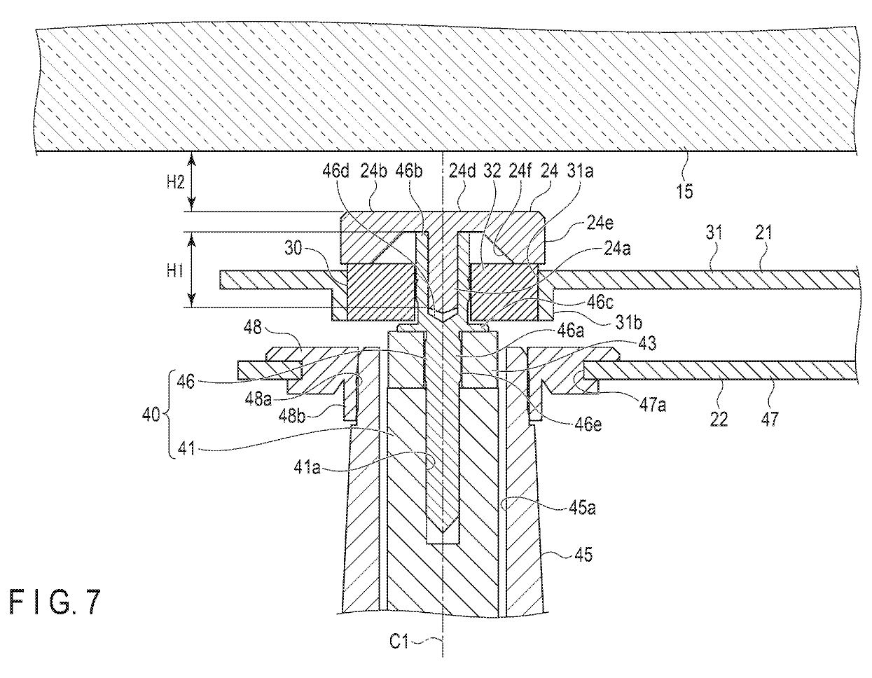

Note that the foregoing one or more embodiments have been presented as examples, and they are not intended to pose any limitations to the scope of the inventions. For example, the foregoing embodiments have assumed an arrangement where the driven magnet 32 is in contact with the first shaft on the flange portion 46c side, but this is not a limitation. As shown in FIG. 7, as another embodiment, the driven magnet 32 may be arranged on the front side of the flange portion 46c of the first shaft 40 with a small gap from the flange portion 46c. In the embodiment shown in FIG. 7, the driven magnet 32 is bonded to or held by the cover 24b of the restricting member 24 by adsorption force from, for example, adhesion or magnetic force, and the driven magnet 32 and the flange portion 46c are placed in an arrangement where they are slightly away from each other in the axial direction. Also, the thickness of the driven magnet 32, which is the length in the first direction, is smaller than the distance in the first direction between the cover 24b of the restricting member 24 and the flange portion 46c. The back side end surface (lower surface) of the peripheral wall 24e, which is an end side part of the peripheral wall 24e, is in contact with the front side surface of the driven magnet 32.

Also, the configuration of the restricting member 24 is not limited to the examples discussed above. While the foregoing embodiments have assumed an exemplary configuration where the minute hand 21 and the hour hand 22 are included, it is also possible to adopt a configuration additionally including other hands such as a second pointer. Also, the foregoing embodiments have assumed an exemplary configuration where the holding structure 30 formed by the magnets 32 and 43 is incorporated into the supporting structure for the minute hand 21, but this is not a limitation. It is possible to adopt a configuration including a magnet-utilizing holding structure as a supporting structure for the hour hand, the second hand, or other hands.

The foregoing embodiments have each assumed an exemplary configuration where the holding structure formed by the magnets 32 and 43 is incorporated into the supporting structure for the minute hand 21, but this is not a limitation. It is possible to adopt a configuration including a magnet-utilizing holding structure as a supporting structure for the hour hand, the second hand, or other hands. Also, the foregoing embodiments have assumed an exemplary configuration where the driving magnet 43 and the driven magnet 32 are formed of hard magnetic materials, but this is not a limitation. For example, one of the magnets may be formed of a soft magnetic material.

Certain embodiments of the present invention have been presented. The present invention is encompassed within the scope of the claims and their equivalents.

This application claims the benefit of Japanese Patent Application No. 2024-191632, filed October 31, 2024, which is hereby incorporated by reference in its entirety.

What is claimed is:

1. A timepiece comprising:
a first magnet fixed to a first pointer;
a second magnet facing the first magnet;
a first shaft fixed to the second magnet;
a restricting member including an engaging shaft and a cover, the engaging shaft being engaged with the first shaft, the cover being arranged on one side of the second magnet and facing the second magnet via the first magnet; and
a windshield member,
wherein the engaging shaft of the restricting member has a length greater than a distance between a surface of the restricting member on the one side and the windshield member.

2. The timepiece according to claim 1, wherein the first magnet is rotatably attached to the first shaft.

3. The timepiece according to claim 1, further comprising a gear train mechanism comprising a first rotating wheel configured to move in conjunction with the first shaft.

4. The timepiece according to claim 1, wherein the cover comprises a peripheral wall defining a recess on another side.

5. The timepiece according to claim 4, wherein the engaging shaft of the restricting member is located in the recess formed inside the peripheral wall.

6. The timepiece according to claim 4, wherein an end of the peripheral wall of the cover of the restricting member is in contact with the first magnet.

7. The timepiece according to claim 1, wherein the first shaft comprises a first shaft portion and a first cylindrical portion located on one side of the first shaft portion, the first cylindrical portion defining an insertion hole into which the engaging shaft of the restricting member is inserted.

8. The timepiece according to claim 7, wherein the engaging shaft of the restricting member is inserted into the first cylindrical portion of the first shaft.

9. The timepiece according to claim 7, wherein a length of a portion of the engaging shaft of the restricting member that has been inserted into the first cylindrical portion of the first shaft is greater than the distance between the surface of the restricting member on the one side and the windshield member.

10. The timepiece according to claim 7, wherein the first shaft further comprises a flange portion between the first shaft portion and the first cylindrical portion.

11. The timepiece according to claim 7, wherein the first cylindrical portion of the first shaft has an end on the one side which is located further toward the one side than the first magnet.

12. The timepiece according to claim 7, wherein the insertion hole of the first cylindrical portion of the first shaft has a depth greater than a thickness of the first magnet.

13. The timepiece according to claim 3, wherein the cover comprises a peripheral wall defining a recess on another side.

14. The timepiece according to claim 13, wherein an end of the peripheral wall of the cover of the restricting member is in contact with the first magnet.

15. The timepiece according to claim 3, wherein the first shaft comprises a first shaft portion and a first cylindrical portion located on one side of the first shaft portion, the first cylindrical portion defining an insertion hole into which the engaging shaft of the restricting member is inserted.

16. The timepiece according to claim 15, wherein the engaging shaft of the restricting member is inserted into the first cylindrical portion of the first shaft.

17. The timepiece according to claim 15, wherein a length of a portion of the engaging shaft of the restricting member that has been inserted into the first cylindrical portion of the first shaft is greater than the distance between the surface of the restricting member on the one side and the windshield member.

18. The timepiece according to claim 15, wherein the first shaft further comprises a flange portion between the first shaft portion and the first cylindrical portion.

19. The timepiece according to claim 15, wherein the first cylindrical portion of the first shaft has an end on the one side which is located further on the one side than the first magnet.

20. The timepiece according to claim 15, wherein the insertion hole of the first cylindrical portion of the first shaft has a depth greater than a thickness of the first magnet.
